(19) United States
(12) Patent Application Publication
(10) Pub. No.: US 2004/0229097 A1
(43) Pub. Date: Nov. 18, 2004

(54) Fuel cell system and associated operation method

(75) Inventors: Shuji Hirakata, Susono-shi (JP); Kenji Umayahara, Susono-shi (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/828,261

(22) Filed: Apr. 21, 2004

(30) Foreign Application Priority Data
May 15, 2003 (JP) 2003-136764

(51) Int. Cl. H01M 8/04

(52) U.S. Cl. 429/24; 429/22; 429/13

(57) ABSTRACT

In a fuel cell system, after a stop instruction is output by the start switch 58, the power generation controller 42 of the controller 40 obtains from the first temperature sensor 31 the temperature indicating the internal temperature of the fuel cell stack. If the obtained temperature equals or is less than a first reference temperature, temperature-maintenance operation is begun. If the obtained temperature comes to equal or exceed a second reference temperature that is higher than the first reference temperature after temperature-maintenance operation is begun, temperature-maintenance operation is stopped. During this process, the abnormality determination unit 44 determines whether or not an abnormality has occurred in the first temperature sensor 31 and issues a warning if an abnormality has occurred.

### BACKGROUND OF THE INVENTION

1. Field of the Invention

This invention relates to a technology for preventing the occurrence of problems caused by the freezing of water in a fuel cell due to a drop in the ambient temperature of the fuel cell system.

2. Description of the Related Art

In a typical fuel cell, water is created as a byproduct of electrochemical reaction. Where a steam reforming reaction is used to generate hydrogen to be supplied to the fuel cell, the hydrogen-containing gas supplied to the fuel cell includes a prescribed amount of water vapor. As a result, if the internal temperature of the fuel cell falls to 0° C. or lower, the water inside the fuel cell may freeze. For example, if the generation of power by the fuel cell is stopped when the ambient temperature falls to 0° C. or lower, the water may freeze inside the fuel cell. If the water inside the gas flow path freezes in this manner, the frozen water blocks the gas flow path, thereby interrupting the supply of gas. As a result, the next time the fuel cell is started, the electrochemical reaction may not proceed sufficiently. Therefore, Japanese Laid Open Publication 2001-231108 discloses a technology whereby if the temperature falls while the operation of the fuel cell is stopped, the fuel cell is operated to prevent freezing (temperature maintenance operation).

However, where the operation of the fuel cell is resumed while the system is stopped based on the internal fuel cell temperature or the external temperature as described above, accuracy in temperature detection is essential. In other words, if the detected temperature is not the correct temperature, power generation (temperature-maintenance operation) might not commence even where the temperature is below the freezing point, or temperature-maintenance operation may be carried out when it is not necessary.

### SUMMARY OF THE INVENTION

The present invention was devised in order to eliminate the above problem in the conventional art, and an object thereof is to improve the reliability of the temperature-maintenance operation carried out to prevent the water from freezing inside the fuel cell when the fuel cell system is not operating.

In order to achieve the above object, a first aspect of the present invention provides a fuel cell system including a fuel cell. The fuel cell system pertaining to this first aspect of the present invention includes a temperature detector that detects the fuel cell operating temperature, wherein the fuel cell operating temperature is a temperature that reflects the internal temperature of the fuel cell, a temperature-maintenance operation controller that, if the detected fuel cell operating temperature equals or is less than a first reference temperature while the fuel cell system is not operating, executes temperature-maintenance operation of the fuel cell, an abnormality determination unit that determines whether a detection abnormality regarding the fuel cell operating temperature has occurred in the temperature detector; and a warning issuance unit that issues a warning when the abnormality determination unit determines an abnormality has occurred in the temperature detector.

According to the fuel cell system pertaining to the first aspect of the present invention, the water inside the fuel cell can be prevented from freezing by performing temperature-maintenance operation of the fuel cell when the internal fuel cell temperature drops while the fuel cell system is not operating, and the commencement of temperature-maintenance operation based on an incorrect temperature determination can be prevented through the issuance of a warning when it is determined that an abnormality has occurred in the temperature detector. If temperature-maintenance operation is commenced based on an incorrect temperature determination, there is a danger that temperature-maintenance operation will be performed where there is no possibility of freezing, causing a drop in the energy efficiency of the fuel cell system as a whole, or that the temperature-maintenance operation will be performed after the water in the fuel cell has frozen. These potential problems can be avoided through the issuance of a warning when an abnormality occurs.

In the fuel cell system pertaining to the first aspect of the present invention, it is acceptable if the temperature-maintenance operation controller stops temperature-maintenance operation when the fuel cell operating temperature detected by the temperature detector during such temperature-maintenance operation of the fuel cell equals or exceeds a second reference temperature which is higher than the first reference temperature.

Using this construction, the termination of temperature-maintenance operation based on an incorrect temperature determination can be prevented through the issuance of a warning when it is determined that an abnormality has occurred in the temperature detector. If temperature-maintenance operation is stopped based on an incorrect temperature determination, temperature-maintenance operation is not stopped even when the fuel cell internal temperature has risen sufficiently, causing a reduction in the energy efficiency of the system, or the temperature-maintenance operation is stopped before the fuel cell temperature has risen sufficiently, thereby causing the water inside the fuel cell to freeze. Such problems can be avoided through the issuance of a warning upon the occurrence of an abnormality.

In the fuel cell system pertaining to the first aspect of the present invention, it is acceptable the fuel cell system includes a plurality of the temperature detectors, the abnormality determination unit determines whether an abnormality has occurred in each of the plural temperature detectors, and when the abnormality determination unit determines an abnormality has occurred in any of the plural temperature detectors, the temperature-maintenance controller performs control pertaining to the temperature-maintenance operation based on the result of detection by the other temperature detectors as to which no abnormality was determined to exist.

Using this construction, because plural temperature detectors are used, and when an abnormality is detected in any of the plural temperature detectors, a warning is issued and temperature-maintenance control is performed using the remaining temperature detectors, the reliability of the temperature-maintenance operation can be improved.

A second aspect of the present invention provides a fuel cell system including a fuel cell. The fuel cell system pertaining to this second aspect of the present invention includes a plurality of temperature detectors that detect a fuel cell operating temperature, wherein the fuel cell operating temperature is a temperature that reflects the internal temperature of the fuel cell, an abnormality determination unit that determines whether a detection abnormality has occurred regarding the fuel cell operating temperature in any of the plural temperature detectors, and a temperature-maintenance operation controller that, when the abnormality determination unit determines that an abnormality has occurred in any of the temperature detectors while the fuel cell system is not operating, executes temperature-maintenance operation of the fuel cell if the detected fuel cell operating temperature as detected by remaining temperature detectors that are determined that no abnormality has been occurred by the abnormality determination unit equals or is less than a first reference temperature.

According to the second aspect of the present invention, because where an abnormality exists in any of the plural temperature detectors, temperature-maintenance operation is carried out based on the fuel cell operating temperature detected by those temperature detectors among the plural temperature detectors as to which no abnormality is determined to exist, the commencement of temperature-maintenance operation based on an incorrect temperature determination is prevented, and the reliability of the operation to begin the temperature-maintenance operation can be improved.

In the fuel cell system pertaining to the second aspect of the present invention, it is acceptable if wherein the temperature-maintenance controller terminates the temperature-maintenance operation if any of the fuel cell operating temperature, which is detected by the remaining temperature detectors during the temperature-maintenance operation, equals or exceeds a second reference temperature that is higher than the first reference temperature.

Using this construction, because the temperature-maintenance operation is stopped based on the fuel cell temperature as detected by only those temperature detectors that are determined to be free of any abnormality, the termination of temperature-maintenance operation based on an incorrect temperature determination can be prevented, and the reliability of the operation to commence the temperature-maintenance operation can be increased.

In the fuel cell system pertaining to the first or second aspect of the present invention, it is acceptable if the abnormality determination unit determines that an abnormality exists when a signal indicating disconnection or short-circuit is output from a temperature detector. Using such a construction, the occurrence of an abnormality in a temperature detector can be easily determined.

A third aspect of the present invention provides an operation method for a fuel cell system that detects the fuel cell operating temperature, which is the temperature that reflects the internal temperature of the fuel cell, and executes temperature-maintenance operation of the fuel cell where the detected fuel cell operating temperature equals or falls below a first reference temperature. The fuel cell system operation method pertaining to the third aspect of the present invention includes determining whether an abnormality has been occurred in the temperature detector that detecting the fuel cell operating temperature when the fuel cell operating temperature is detected, and issuing a warning when an abnormality is detected in the temperature detector.

According to the fuel cell system operation method pertaining to the third aspect of the present invention, because when the temperature of the fuel cell is detected, it is determined whether an abnormality has been occurred in the temperature detector that detected the fuel cell operating temperature, and a warning is issued in the event that an abnormality is detected in the temperature detector, the commencement of temperature-maintenance operation based on an incorrect temperature determination can be prevented.

It is furthermore acceptable in the fuel cell system operation method pertaining to the third aspect of the present invention may further include detecting the fuel cell operating temperature while the fuel cell is in a temperature-maintenance operation, and stopping the temperature-maintenance operation when the detected fuel cell temperature equals or exceeds a second reference temperature that is higher than the first reference temperature..

The present invention can be implemented in various forms other than those described above. For example, it may be implemented in the form of an operating program for a fuel cell, or in the form of a recording medium on which such program is recorded.

### BRIEF DESCRIPTION OF THE DRAWINGS

FIG. 1 is a block diagram showing the basic construction of an electric automobile in which a fuel cell system comprising an embodiment of the present invention is installed;

FIG. 2 is a block diagram showing the construction of a circuit pertaining to processes to determine whether temperature-maintenance operation is required and whether an abnormality exists in a temperature sensor;

FIG. 3 is a flow chart showing a temperature-maintenance operation control processing routine;

FIG. 4 is a flow chart showing an abnormality determination processing routine;

FIG. 5 is a flow chart showing an abnormality determination processing routine comprising a variation of the first embodiment;

FIG. 6 is a block diagram showing the basic construction of an electric automobile in which a fuel cell system is installed;

FIG. 7 is a flow chart showing an abnormality determination processing routine; and

FIG. 8 is a flow chart showing a temperature-maintenance operation control processing routine.

### DETAILED DESCRIPTION OF THE PREFERRED EMBODIMENTS

Embodiments of the present invention will be described below with reference to the drawings.

A. Overall Construction of Apparatus

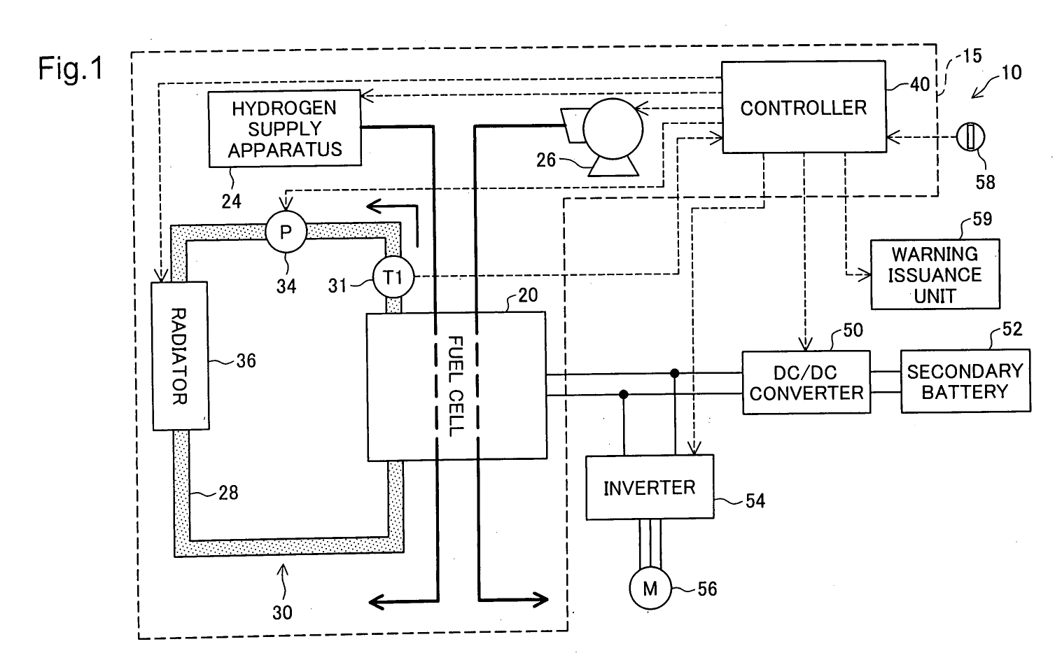

FIG. 1 is a block diagram showing the basic construction of an electric automobile in which a fuel cell system comprising an embodiment of the present invention is installed.

The fuel cell system 15 is a primary power source for an electric automobile 10, and includes a fuel cell stack 20, a hydrogen gas supply apparatus 24, a blower 26 and a cooling device 26. While various types of fuel cells may be used for the fuel cell stack 20, in this embodiment, solid macromolecule fuel cells are used for the fuel cell stack 20.

The hydrogen gas supply apparatus 24 is an apparatus that supplies hydrogen gas that is stored inside the apparatus to the anode of the fuel cell stack 20 as fuel gas. For example, the hydrogen supply apparatus 24 may comprise a hydrogen cylinder or a hydrogen tank containing a hydrogen-occluded alloy. The fuel exhaust gas expelled from the anode after it is used for electrochemical reaction can be used once more for electrochemical reaction by guiding it to a flow path that connects the hydrogen supply apparatus 24 with the fuel cell stack 20 (not shown). Air is supplied by the blower 26 to the cathode of the fuel cell stack 20 as oxidization gas.

The cooling device 30 includes a coolant path 28 that is formed such that it travels inside the fuel cell stack 20, a radiator 36, and a pump 34. Driving the pump 34 enables the coolant to be circulated in the coolant path 28. When electrochemical reaction occurs in the fuel cell stack 20, heat is generated. Accordingly, by circulating coolant within the fuel cell stack 20 during power generation and cooling the coolant via the radiator 36, the operating temperature of the fuel cell stack 20 can be maintained within a prescribed range. The radiator 36 includes a cooling fan not shown, and cooling of the coolant by the radiator 36 can be promoted through the driving of this cooling fan. A first temperature sensor 31 is disposed in the coolant path 28 near the area of its connection to the fuel cell stack 20 and on the side thereof at which coolant is expelled from the fuel cell stack 20. In FIG. 1, the direction of circulation of the coolant within the coolant path 28 is indicated by an arrow.

The electric automobile 10 includes a secondary battery 52, which serves as a supplementary power source, in addition to the fuel cell system 15 described above. The secondary battery 52 is connected in parallel in relation to the fuel cell stack 20 via a DC/DC converter 50. An inverter 54 generates three-phase alternating current from these direct current power sources and supplies it to the motor 56 used to drive the vehicle. This [supplied] current controls the rotation speed and torque of the motor 56.

A controller 40 is constructed as a logic circuit revolving around a microcomputer, and controls the movement of each component of the electric automobile 10, including the fuel cell system 15. In other words, it receives signals from the various sensors disposed in the electric automobile 10 such as the detection signals from the first temperature sensor 31, as well as outputs drive signals to the various components of [of the fuel cell system 15] such as the blower 26 and the pump 34 or the various components of [the electric automobile 10] such as the DC/DC converter 50 and the inverter 54. Furthermore, a start switch 58 that is used to input instructions to globally start and stop the vehicle system is disposed in the electric automobile 10, and the controller 40 receives ON/OFF signals (instructing system startup or shutdown) from the start switch 58. A warning issuance unit 59 that issues a warning when an abnormality is detected in the temperature sensor is disposed in the electric automobile 10, and the controller 40 outputs control signals to this warning issuance unit 59. In FIG. 1, the controller 40 is assumed to perform control for the entire electric automobile 10, including the fuel cell system 15, but it is acceptable if the controller pertaining to the fuel cell system 10 is different from the controller pertaining to the driving of the vehicle. In such a case, information should be exchanged between the two controllers, such that control to carry out the operations described below is carried out with respect to the vehicle as a whole.

B. Operation

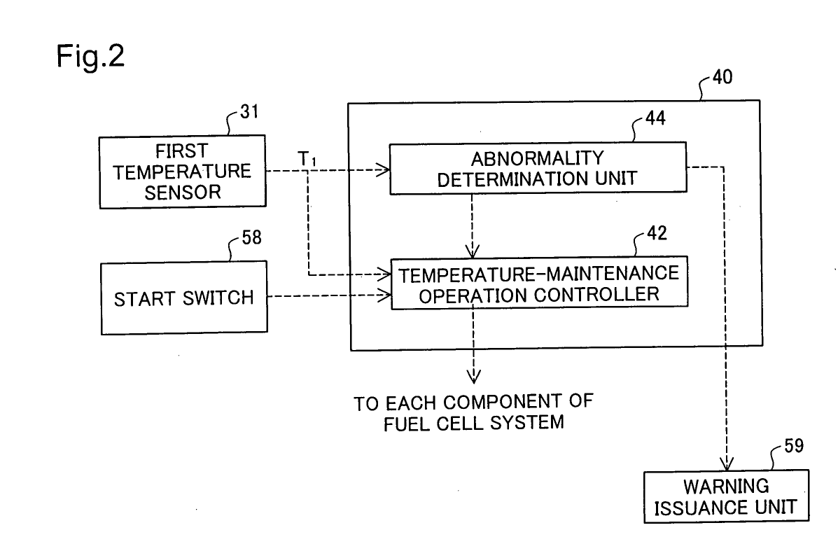

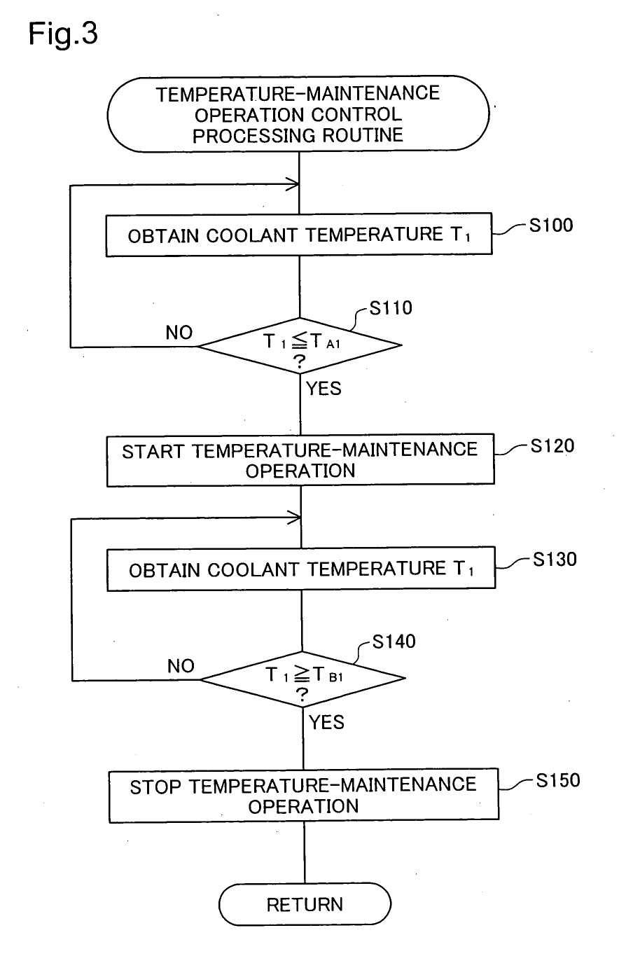

FIG. 2 is a block diagram showing the construction of a circuit that is disposed in the electric automobile 10 and pertains to processes to determine whether temperature-maintenance operation is required and whether an abnormality exists in the temperature sensor. As shown in FIG. 2, the controller 40 includes a temperature-maintenance operation controller 42 and an abnormality determination unit 44. FIG. 3 is a flow chart showing a temperature-maintenance operation control processing routine that is executed by the controller 40 of the electric automobile 10. When the switch 58 of the electric automobile 10 is moved from the ON position to the OFF position, thereby stopping the [operation of] the fuel cell system 15, this routine is executed repeatedly until the switch 58 is once more switched to the ON position.

When this routine is executed, the temperature-maintenance operation controller 42 of the controller 40 first obtains a coolant temperature T1 from the first temperature sensor 31 (step S100). When the coolant temperature T1 is obtained, the temperature-maintenance operation controller 42 determines whether or not this coolant temperature T1 is equal to or less than a first reference temperature TA1 (step S110). Here, the coolant temperature T1 reflects the temperature inside the fuel cell stack 20. The reference temperature TA1 is the coolant temperature at which it is possible that the water inside the fuel cell stack 20 will freeze, and is stored in the controller 40 as a preset value. For example, the first reference temperature TA1 is set to 2° C. in this embodiment. Where the coolant temperature T1 is determined to equal or exceed the reference temperature TA1 in step S110, the temperature-maintenance operation controller 42 determines that the water inside the fuel cell stack 20 will not freeze, and returns to step S100. It then repeats the operation of step S110 in which the controller 40 determines whether or not the coolant temperature T1 is equal to or less than the first reference temperature TA1.

If it is determined in step S110 that the coolant temperature T1 equals or is less than the reference temperature TA1, the temperature-maintenance operation controller 42 outputs drive signals to the various components of the fuel cell system 15 and commences temperature-maintenance operation (step S120). Specifically, the controller 40 drives the hydrogen supply apparatus 24 and the blower 26 to begin the supply of hydrogen (fuel gas) and air (oxidization gas) to the fuel cell stack 20. It also drives the pump 34 to begin the circulation of coolant in the coolant path 28. Because the purpose of this temperature-maintenance operation is to prevent a drop in the temperature inside the fuel cell stack 20, the cooling fan comprising part of the radiator 36 and not shown in the drawings is not driven during temperature-maintenance operation. In addition, because it is not necessary to drive the motor 56, the amount of power generated during temperature-maintenance operation is kept very small. Specifically, the amount of power generated by the fuel cell stack 20 is limited to the level necessary to cover the amount of power consumed by the fuel cell auxiliary equipment such as the hydrogen supply apparatus 24, the blower 26 and the pump 34. Here, because the amount of power that can be generated per unit of gas supplied to the fuel cell stack 20 varies depending on the internal temperature of the fuel cell stack 20, the amount of driving of the above fuel cell auxiliary equipment during temperature-maintenance operation can be adjusted based on the coolant temperature T1 detected by the first temperature sensor 31. Furthermore, in order to increase the temperature of the fuel cell stack 20, a heater that heats the fuel cell stack 20 or the coolant may be disposed [adjacent thereto], such that some of the power generated by the fuel cell stack 20 is diverted to the heater to provide heat during temperature-maintenance operation. Moreover, if the amount of power remaining in the secondary battery is low, the secondary battery may be charged during temperature-maintenance operation.

When temperature-maintenance operation is begun, the temperature-maintenance operation controller 42 obtains the coolant temperature T1 from the first temperature sensor 31 (step S130). When the coolant temperature T1 is obtained, the temperature-maintenance operation controller 42 then determines whether or not this coolant temperature T1 equals or exceeds a second reference temperature TB1 (step S140). The second reference temperature TB1 is a reference temperature that indicates that the temperature inside the fuel cell stack 20 has risen sufficiently, and is a preset value stored in the controller 40. For example, in this embodiment, the second reference temperature TB1 is set at 7° C. If [it is determined] in step S140 that the coolant temperature T1 has not reached the second reference temperature TB1, it is determined that the water in the fuel cell stack 20 could freeze, [the controller 40] returns to step S130, and performs the operation of comparing the detected coolant temperature T1 with the second reference temperature TB1 once more in step S140.

If the coolant temperature T1 is determined in step S140 to equal or exceed the second reference temperature TB1, the temperature-maintenance operation controller 42 stops the temperature-maintenance operation (step S150) and ends the routine. By repeating this operation, the fuel cell stack 20 is maintained within a temperature range in which there is no danger of the water inside freezing, even if the start switch 58 is OFF. Here, if the second reference temperature TB1 is set too high, a large amount of heat is discharged outside the system during temperature-maintenance operation. Accordingly, it is preferred that the second reference temperature TB1 be set as low as possible within a range that permits the temperature-maintenance operation shown in FIG. 3 to be started and stopped without difficulty, while taking into consideration the accuracy of the first temperature sensor 31. For example, in this embodiment, the second reference temperature TB1 is set to a temperature 5° C. higher than the first reference temperature TA1.

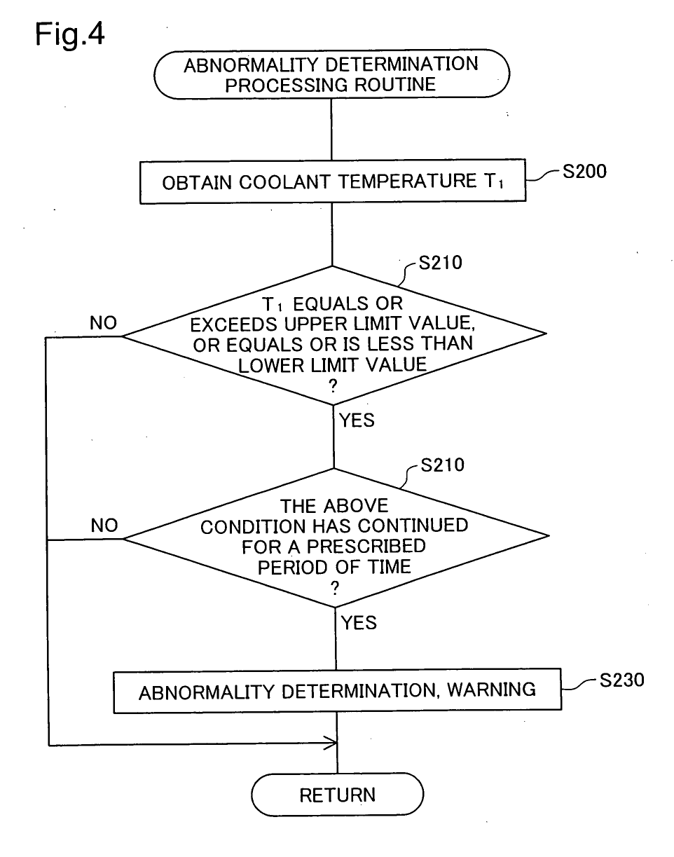

FIG. 4 is a flow chart showing the abnormality determination processing routine executed by the controller 40 of the electric automobile 10. This routine is executed repeatedly and independently while the temperature-maintenance operation control processing routine described above is being performed.

When this routine is executed, the abnormality determination unit 44 of the controller 40 first obtains the coolant temperature T1 from the first temperature sensor 31 (step S200). When the coolant temperature T1 is obtained, the abnormality determination unit 44 determines whether or not the coolant temperature T1 is at or above the upper limit value or at or below the lower limit value (step S210). Here, the upper and lower limit values are values set in advance and stored in the controller 40 that represent abnormal values that fall outside the range of measurement of the first sensor 31 under the normal operating environment for the fuel cell system 15. In this embodiment, for example, the upper limit value is set to 120° C., while the lower limit value is set to −30° C. If the coolant temperature T1 is between the upper and lower limit values, it is determined that no abnormality exists in the first temperature sensor 31, and the routine is ended without further processing.

If it is determined in step S210 that the coolant temperature T1 is at or above the upper limit value or at or below the lower limit value, the abnormality determination unit 44 determines whether or not the state in which the coolant temperature T1 is at or above the upper limit value or at or below the lower limit value has continued for a prescribed period of time set in advance (step S220). The prescribed period of time for purposes of step S220 is intended to eliminate the effects of noise or the like, and is set to one second in this embodiment, for example. Where the state in which the coolant temperature T1 is at or above the upper limit value or at or below the lower limit value has not continued for the prescribed period of time, the detection of the abnormal value is deemed to be the result of noise or the like, and it is determined that there is no abnormality in the first sensor 31, whereupon the routine ends without further processing.

If it is determined in step S220 that the state in which the coolant temperature T1 is at or above the upper limit value or at or below the lower limit value has continued for the prescribed period of time or longer, the abnormality determination unit 44 determines that an abnormality has occurred in the first temperature sensor 31 and outputs a drive signal to the warning issuance unit 59 (step S230), whereupon the routine ends. This warning issuance unit 59 notifies the operator of the electric automobile 10 that an abnormality has occurred in the first temperature sensor 31 through the issuance of a warning. The warning issuance unit 59 may constitute a display screen, sound generating means or a warning lamp mounted to the electric automobile 10. The operator may be notified of the occurrence of an abnormality through the display of a warning on a display screen, the emission of a warning sound or the illumination of a warning lamp. A sound or warning lamp is preferred because the warning can be easily discernible even where the operator is located at a distance from the electric automobile 10.

According to the fuel cell system 15 of the first embodiment having the construction described above, the freezing of water in the fuel cell can be prevented by carrying out temperature-maintenance operation when the temperature inside the fuel cell stack 20 drops while the system is not operating, and the operator can be notified of the occurrence of an abnormality through the emission of a warning when it is determined that an abnormality has occurred in the first temperature sensor 31. As a result, the continuation of control to start or stop temperature-maintenance operation based on an incorrect temperature determination can be prevented. In other words, the problems of (i) a drop in the energy efficiency of the overall system caused by the performance of temperature-maintenance operation when there is no danger of freezing, or (ii) the commencement of temperature-maintenance operation after the water inside the fuel cell stack 20 has frozen, both of which are caused by starting temperature-maintenance operation based on an incorrect temperature determination, can be prevented. Furthermore, the problems of (i) a drop in the energy efficiency of the overall system caused by temperature-maintenance operation continued based on an incorrect temperature determination, even where the temperature of the fuel cell stack 20 has already been raised sufficiently, or (ii) the freezing of the water inside the fuel cell stack 20 due to the stoppage of temperature-maintenance operation before the temperature of the fuel cell stack 20 has risen sufficiently, both of which are caused by stopping temperature-maintenance operation based on an incorrect temperature determination, can be prevented.

In the above embodiment, the determination regarding the existence of an abnormality in the temperature sensor 31 was made based on the coolant temperature T1 detected from an output signal from the first temperature sensor 31, but it is acceptable if it is made based directly on the first temperature sensor 31 output signal. Where the first temperature sensor 31 comprises a thermistor, it can be determined that an abnormality has occurred in the first temperature sensor 31 when the output voltage value relative to the impressed voltage deviates from the value corresponding to the upper limit temperature value or lower limit temperature value described above. For example, reference values may be established whereby it is determined that an abnormality has occurred if, where the impressed voltage is 0.5V, the output voltage equals or exceeds the value of 0.49V corresponding to the upper limit temperature of 120° C., or equals or is lower than the value of 0.01V corresponding to the lower limit temperature of −30° C. In this way, if the temperature sensor output voltage is a large value that exceeds the normal range of detection signals, it is assumed that a short-circuit has occurred in the wiring to the temperature sensor. Similarly, if the temperature sensor output voltage is a small value close to 0V that exceeds the normal range of detection signals, it is assumed that a disconnection has occurred in the wiring to the temperature sensor. Therefore, it is acceptable if the type of abnormality is displayed on the display screen or the like when a warning is issued.

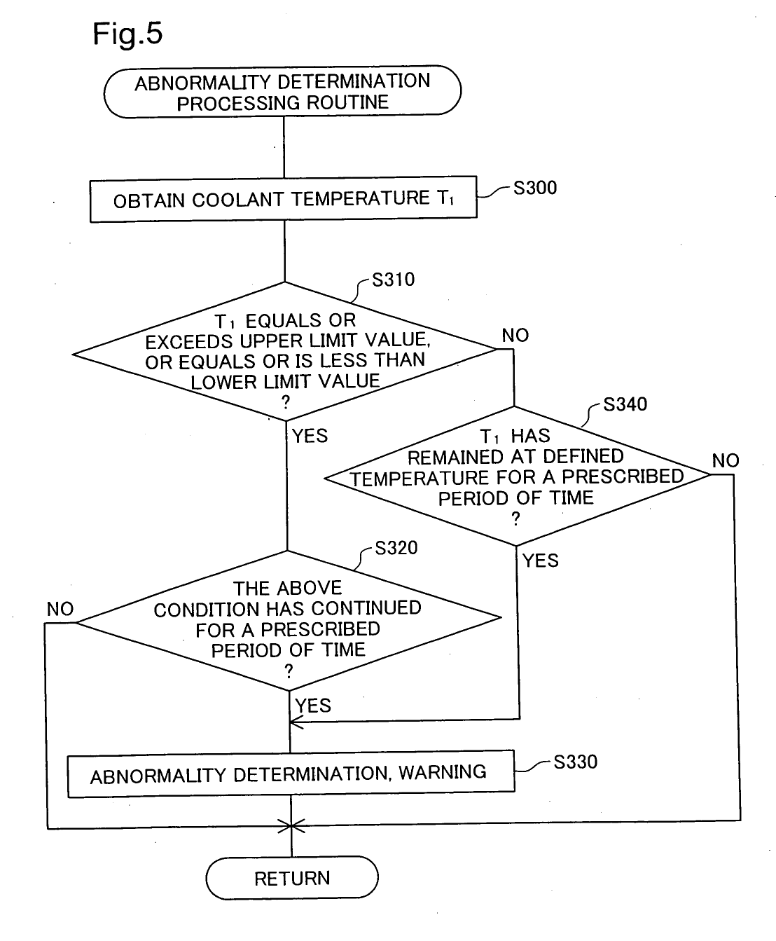

In the first embodiment described above, the occurrence of an abnormality, such as a disconnection or a short-circuit, is detected in the first temperature sensor 31 by comparing the detected coolant value T1 with the upper and lower limit values, but various other types of abnormalities in the temperature sensor can exist as well. FIG. 5 is a flow chart showing an abnormality determination processing routine constituting a variation of the first embodiment. Here, in addition to the abnormality determination described in connection with the first embodiment, abnormalities occurring in the first temperature sensor 31 during the signal processing stage can also be detected.

The abnormality determination processing routine of FIG. 5 is performed repeatedly and independently during the temperature-maintenance control processing routine described above in place of the processing shown in FIG. 4 by the controller 40 of an electric automobile 10 similar to the one described in connection with the first embodiment.

Steps S300-S330 of this routine are the same as the steps S200-S230 of the abnormality determination processing routine shown in FIG. 4, [such that] when the detected coolant temperature T1 equals or exceeds the upper limit value or equals or is less than the lower limit value, the abnormality determination unit 44 determines that an abnormality has occurred in the first temperature sensor 31 and issues a warning. In the abnormality determination processing routine shown in FIG. 5, if it is determined in step S310 that the coolant temperature T1 does not equal or exceed the upper limit value and is not equal to or less than the lower limit value, the abnormality determination unit 44 determines whether or not the coolant temperature T1 has remained at a defined temperature for a prescribed period of time (step S340). The prescribed period of time and the range of defined temperatures in this step S340 are stored in advance in the controller 40 as the time period and range of temperatures within which a temperature change is expected under normal circumstances where the fuel cell 15 is left alone. For example, in this embodiment, the prescribed period of time is set to 10 minutes, and the range of defined temperatures is set to ±1° C.

In step S340, if the coolant temperature T1 remains at a defined temperature for a prescribed period of time, the abnormality determination unit 44 determines that an abnormality has occurred in the first temperature sensor 31 during the signal processing stage, a warning is issued indicating that an abnormality has occurred in the first temperature sensor 31 (step S330), and the routine ends. On the other hand, if the coolant temperature T1 does not remain at a defined temperature for a prescribed period of time, it is determined in step S340 that an abnormality does not exist in the first temperature sensor 31, and the routine ends without further processing.

C. Second Embodiment

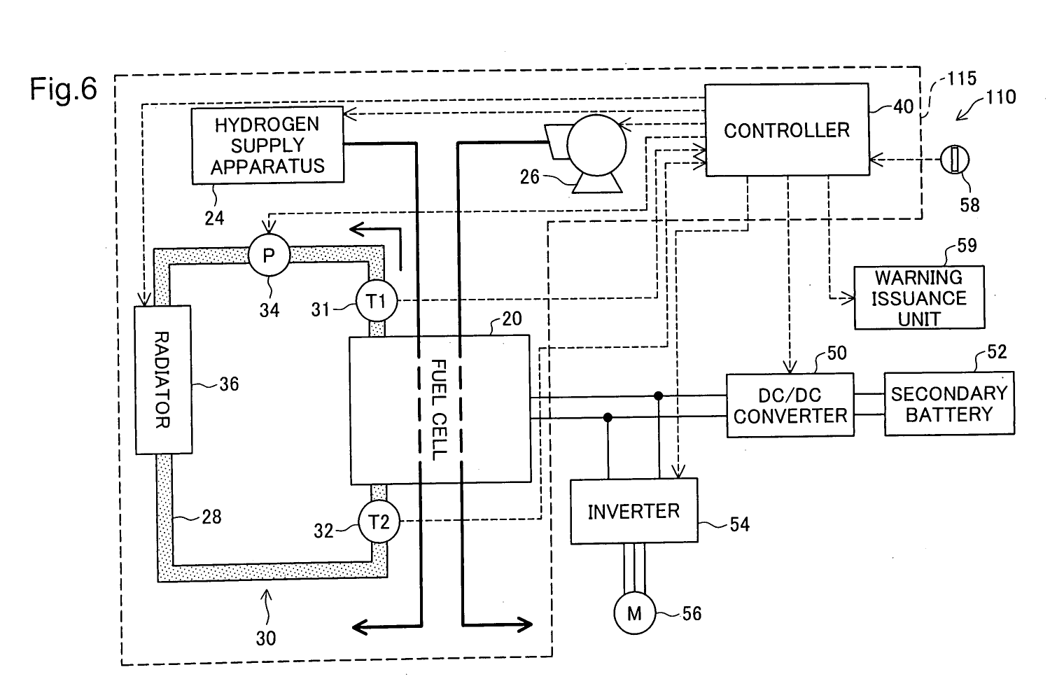

FIG. 6 is a block diagram showing the basic construction of an electric automobile 110 in which the fuel cell system 115 of the second embodiment is installed. Because the electric automobile 110 of the second embodiment has a construction similar to that of the electric automobile 10 of the first embodiment, common constituent elements will be assigned the same reference symbols, but detailed description thereof will be omitted. The fuel cell system 115 of the second embodiment includes in the coolant path 28, in addition to the first temperature sensor 31, a second temperature sensor 32 that detects the temperature T2 of the coolant flowing into the fuel cell stack 20. The second temperature sensor 32 is disposed near the area of connection [of the coolant path 28] on the side at which the coolant flows into the fuel cell stack 20.

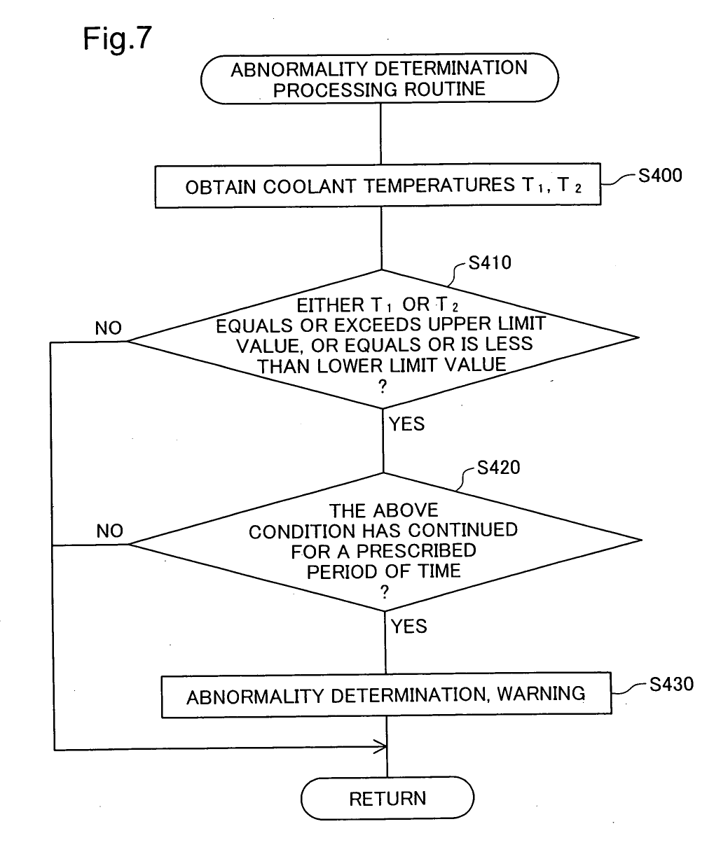

FIG. 7 is a flow chart showing the abnormality determination processing routine executed by the controller 40 of the electric automobile 110 of the second embodiment. This routine is executed repeatedly in place of the abnormality determination processing routine of the first embodiment shown in FIG. 4.

When this routine is executed, the abnormality determination unit 44 of the controller 40 first obtains the coolant temperatures T1 and T2 from the first and second temperature sensors 31 and 32, respectively (step S400). The abnormality determination unit 44 then determines whether or not these coolant temperatures T1 and T2 equal or exceed or fall below, respectively, upper and lower limit values set in advance, in the same manner as in step S210 in FIG. 4 (step S410). As in the first embodiment, the upper and lower limit values referred to in step S410 are preset and stored in the controller 40 as reference values for abnormal values that are not normally detected. In step S410, if both the coolant temperatures T1 and T2 fall between the upper and lower limit values, it is determined that no abnormality has occurred in either the first temperature sensor 31 or the second temperature sensor 32, whereupon the routine ends.

In step S410, if the detected value for either the coolant temperature T1 or the coolant temperature T2 equals or is above or below the respective limit value, the abnormality determination unit 44 determines whether or not the state indicated by the abnormal value has been in existence for a preset prescribed period of time, as in step S220 (step S420). If the state indicated by the abnormal value has not been in existence for the prescribed period of time, it is determined that an abnormality does not exist in the temperature sensor in which the abnormal value was detected, and the abnormality determination unit 44 ends the routine without further processing.

If it is determined in step S420 that the state in which an abnormal value is detected has existed for at least the prescribed period of time in either temperature sensor, the abnormality determination unit 44 determines that an abnormality exists in the temperature sensor in which this abnormal value was detected and outputs a control signal to the warning issuance unit 59 (step S430), whereupon the routine ends. Where it is determined in step S430 that an abnormality exists in either temperature sensor, the abnormality determination unit 44 also outputs information to the temperature-maintenance operation controller 42 identifying the temperature sensor experiencing the abnormality. In addition, in the abnormality determination process shown in FIG. 7, it is acceptable if such determination takes into account abnormalities that occur during the signal processing stage, as with the process shown in FIG. 5.

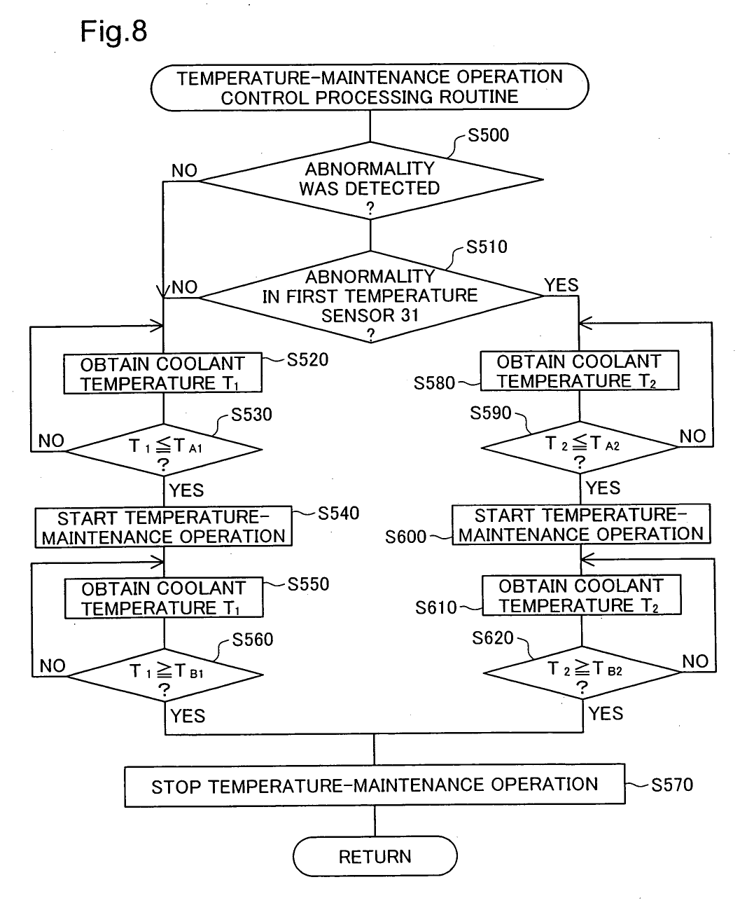

FIG. 8 is a flow chart showing the temperature-maintenance operation control processing routine executed by the controller 40 of the electric automobile 110 of the second embodiment. This routine is repeatedly executed in place of the temperature-maintenance operation processing routine of the first embodiment shown in FIG. 3.

When this routine is executed, the temperature-maintenance operation controller 42 of the controller 40 first determines whether or not the occurrence of an abnormality has been detected in either the first temperature sensor 31 or the second temperature sensor 32 (step S500). This determination is based on whether or not information indicating the existence of an abnormality in either sensor was transmitted to the temperature-maintenance operation controller 42 in step S430.

If an abnormality is determined to have been detected in step S500, the temperature-maintenance operation controller 42 determines whether or not this abnormality exists in the first temperature sensor 31 (step S5 10). If it is determined that the abnormality is in the second temperature sensor 32 rather than the first temperature sensor 31, the temperature-maintenance operation controller 42 executes the processes of steps S520-S570, which correspond to the processes of steps S100-S150 of FIG. 3, whereupon the routine ends. In other words, control to start and stop temperature-maintenance operation is executed based on the coolant temperature T1 detected by the first temperature sensor 31.

On the other hand, if it is determined in step S510 that an abnormality exists in the first temperature sensor 31, the temperature-maintenance operation controller 42 executes control to start and stop temperature-maintenance operation based on the coolant temperature T2 detected by the second temperature sensor 32 (steps S580-S620 and step S570), whereupon the routine ends. These processes correspond to the processes of steps S520-S570. Here, instead of the first and second reference temperatures TA1 and TB1 established for the purpose of making the determination based on the coolant temperature T1, the determination is made based on a first reference temperature TA2 and a second reference temperature TB2 established for the purpose of making the determination based on the coolant temperature T2.

If an abnormality was not detected in either temperature sensor in step S500, control to start and stop temperature-maintenance operation is carried out based on the coolant temperature detected by either temperature sensor. In this embodiment, when both temperature sensors are functioning normally, control is executed based on the coolant temperature T1 detected by the first temperature sensor 31 (steps S520-S570).

According to the fuel cell system 115 of the second embodiment having the above construction, because (i) multiple temperature sensors are used, and (ii) if an abnormality is detected in either temperature sensor, a warning is issued and control is executed to perform temperature-maintenance operation using the other temperature sensor, the reliability of the temperature-maintenance operation can be improved. In other words, the commencement and termination of temperature-maintenance operation based on an incorrect temperature determination can be prevented. Furthermore, in the second embodiment, a first temperature sensor 31 and a second temperature sensor 32 were used for detection of the internal temperature of the fuel cell stack 20, but the same control process may be executed using three or more temperature sensors.

D. Other Embodiments

This invention is not limited to the examples and embodiments described above, and may be implemented in various forms within the essential scope of the invention. For example, the variations described below may be employed.

(1) In the first and second embodiments, the temperature-maintenance operation was controlled based on the coolant temperature, but it is acceptable if the stack internal temperature is detected directly, and various measurement values may be used for this purpose so long as the value chosen accurately reflects the internal temperature of the fuel cell stack 20. For example, if an apparatus that includes a reformer instead of an apparatus that stores hydrogen gas is used as the hydrogen supply apparatus 24, the determination may be made based on the internal temperature of the reformer or on the temperature of the fuel gas supplied to the fuel cell stack 20.

During operation of the fuel cell system in order to perform temperature-maintenance operation, the temperature inside the fuel cell stack may be determined based on the output current or output voltage from the fuel cell stack. Because the output voltage value associated with the output current of the fuel cell characteristically changes in accordance with the internal temperature of the fuel cell stack, the determination of whether the fuel cell stack internal temperature has risen sufficiently can be made based on detection of the output current and output voltage.

Alternatively, the atmospheric temperature may be detected as a value to reflect the internal temperature of the fuel cell stack 20. Here, where the an abnormality exists in the other temperature detector and determination of the need to carry out temperature-maintenance operation is made based solely on the atmospheric temperature, if the atmospheric temperature remains at or below a prescribed temperature for a sustained period of time, temperature-maintenance operation may be continued longer than necessary. As a result, in this situation, it is acceptable if a process wherein temperature-maintenance operation is carried out for a prescribed period of time and such operation is then suspended for another prescribed period of time is executed repeatedly.

(2) In the first and second embodiments, the fuel cell stack 20 and the secondary battery 52 are connected to the load in parallel, such that they can be both used as power sources, but a different construction may be utilized. For example, a construction may be employed wherein the secondary battery 52 is used only to drive the vehicle auxiliary equipment, and only the fuel cell is used as the power source to drive the vehicle. The same effect may be obtained from application of the present invention where the fuel cell supplies power to the load while the system is running, and fuel cell operation is stopped when the system is stopped.

(3) Furthermore, while in the above embodiments, the fuel cell system was installed in an electric automobile, the same effect can be obtained from application of the present invention where the fuel cell system is used as a stationary power source.

What is claimed is:

1. A fuel cell system equipped with a fuel cell, said fuel cell system comprising:
a temperature detector that detects the fuel cell operating temperature, wherein the fuel cell operating temperature is a temperature that reflects the internal temperature of said fuel cell;
a temperature-maintenance operation controller that, if said detected fuel cell operating temperature equals or is less than a first reference temperature while said fuel cell system is not operating, executes temperature-maintenance operation of said fuel cell;
an abnormality determination unit that determines whether a detection abnormality regarding said fuel cell operating temperature has occurred in said temperature detector; and
a warning issuance unit that issues a warning when said abnormality determination unit determines an abnormality has occurred in said temperature detector.

2. A fuel cell system according to claim 1, wherein said temperature-maintenance operation controller stops said temperature-maintenance operation when said fuel cell operating temperature detected by said temperature detector during said temperature-maintenance operation of the fuel cell equals or exceeds a second reference temperature which is higher than said first reference temperature.

3. A fuel cell system according to claim 2, wherein said fuel cell system includes a plurality of said temperature detectors,
said abnormality determination unit determines whether an abnormality has occurred in each of said plural temperature detectors, and
when said abnormality determination unit determines an abnormality has occurred in any of said plural temperature detectors, said temperature-maintenance controller performs control pertaining to said temperature-maintenance operation based on the result of detection by the other temperature detectors as to which no abnormality was determined to exist.

4. A fuel cell system equipped with a fuel cell, said fuel cell system comprising:
a plurality of temperature detectors that detect a fuel cell operating temperature, wherein the fuel cell operating temperature is a temperature that reflects the internal temperature of said fuel cell;
an abnormality determination unit that determines whether a detection abnormality has occurred regarding said fuel cell operating temperature in any of said plural temperature detectors; and
a temperature-maintenance operation controller that, when said abnormality determination unit determines that an abnormality has occurred in any of said temperature detectors while said fuel cell system is not operating, executes temperature-maintenance operation of said fuel cell if said detected fuel cell operating temperature as detected by remaining temperature detectors that are determined that no abnormality has been occurred by said abnormality determination unit equals or is less than a first reference temperature.

5. A fuel cell system according to claim 4, wherein said temperature-maintenance controller terminates said temperature-maintenance operation if any of said fuel cell operating temperature, which is detected by the remaining temperature detectors during said temperature-maintenance operation, equals or exceeds a second reference temperature that is higher than said first reference temperature.

6. A fuel cell system according to claim 1, wherein said abnormality determination unit determines that an abnormality exists when a signal indicating disconnection or short-circuit is output from said temperature detector.

7. A fuel cell system according to claim 2, wherein said abnormality determination unit determines that an abnormality exists when a signal indicating disconnection or short-circuit is output from said temperature detector.

8. A fuel cell system according to claim 3, wherein said abnormality determination unit determines that an abnormality exists when a signal indicating disconnection or short-circuit is output from said temperature detector.

9. A fuel cell system according to claim 4, wherein said abnormality determination unit determines that an abnormality exists when a signal indicating disconnection or short-circuit is output from said temperature detector.

10. A fuel cell system according to claim 5, wherein said abnormality determination unit determines that an abnormality exists when a signal indicating disconnection or short-circuit is output from said temperature detector.

11. An operation method for a fuel cell system that detects the fuel cell operating temperature, which is a temperature that reflects the internal temperature of the fuel cell, and executes temperature-maintenance operation of the fuel cell where the detected fuel cell operating temperature equals or falls below a first reference temperature, said method comprising:
determining whether an abnormality has been occurred in the temperature detector that detecting said fuel cell operating temperature when said fuel cell operating temperature is detected; and
issuing a warning when an abnormality is detected in said temperature detector.

12. A fuel cell system operation method according to claim 11 further comprising:
detecting the fuel cell operating temperature while said fuel cell is in a temperature-maintenance operation; and
stopping said temperature-maintenance operation when said detected fuel cell temperature equals or exceeds a second reference temperature that is higher than said first reference temperature.
